(19) United States
(12) Patent Application Publication
(10) Pub. No.: US 2020/0387161 A1
(43) Pub. Date: Dec. 10, 2020

(54) SYSTEMS AND METHODS FOR TRAINING AN AUTONOMOUS VEHICLE

(71) Applicant: GM GLOBAL TECHNOLOGY OPERATIONS LLC, Detroit, MI (US)

(72) Inventors: Mohammed H. Al Qizwini, Macomb, MI (US); Xuewei Qi, Sterling Heights, MI (US); David H. Clifford, Royal Oak, MI (US)

(73) Assignee: GM GLOBAL TECHNOLOGY OPERATIONS LLC, Detroit, MI (US)

(21) Appl. No.: 16/431,842

(22) Filed: Jun. 5, 2019

(51) Int. Cl. G05D 1/02; G06N 3/08; G06K 9/62

(52) U.S. Cl. CPC G05D 1/0221; G05D 1/0246; G06K 9/6259; G06K 9/6263; G06N 3/08

(57) ABSTRACT

Systems and method are provided for training an autonomous vehicle. In various embodiments, a method includes: storing, in a data storage device, real world data including a sequence of images of a road environment, the sequence of images generated based on a vehicle traversing the road environment; processing, in an offline simulation environment, the sequence of images with a deep reinforcement learning agent associated with a control feature of the autonomous vehicle to obtain an optimized set of control policies; and training the autonomous vehicle based on the optimized set of control polices.

### TECHNICAL FIELD

The present disclosure generally relates to autonomous vehicles, and more particularly relates to systems and methods for training an autonomous vehicle.

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle and perform traffic prediction.

Recent years have seen significant advancements in autonomous vehicles. For example, models associated with certain autonomous control features can be trained using a variety of labeled images of the environment. The images are labeled based on the elements shown in the image. The elements are typically identified and labeled by a human. Using a human to identify and label a variety of images can be time consuming and costly.

Accordingly, it is desirable to provide improved systems and methods for training an autonomous vehicle without the need for labeled images. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for training an autonomous vehicle. In one embodiment, a method includes: storing, in a data storage device, real world data including a sequence of images of a road environment, the sequence of images generated based on a vehicle traversing the road environment; processing, in an offline simulation environment, the sequence of images with a deep reinforcement learning agent associated with a control feature of the autonomous vehicle to obtain an optimized set of control policies; and training the autonomous vehicle based on the optimized set of control polices.

In various embodiments, the processing the sequence of images comprises: obtaining a first image from the sequence of images and processing the first image with the deep reinforcement learning agent to obtain an action; modifying a next image from the sequence of images based on the action; and determining the optimized set of control policies based on the modified next image.

In various embodiments, the method further includes: determining whether the modified next image depicts an unwanted driving behavior, and when the modified next image does not depict an unwanted driving behavior, processing the modified next image with the deep reinforcement learning agent to obtain a next action; when the modified next image does depict an unwanted driving behavior, processing the first image with the deep learning reinforcement agent to obtain the next action.

In various embodiments, the method further includes computing a reward based on the modified next image, and wherein the processing the modified next image is based on the reward.

In various embodiments, the unwanted driving behavior comprises steering off the road.

In various embodiments, the unwanted driving behavior comprises steering into an object.

In various embodiments, the method further includes iteratively processing a next image of the vision sequence with the deep reinforcement learning agent based on a computed reward associated with the next image.

In various embodiments, the control feature includes steering control of the autonomous vehicle.

In various embodiments, the action is associated with a steering angle of a steering system of the autonomous vehicle.

In another embodiment system for training an autonomous vehicle includes: a data storage device that stores real world data including a sequence of images of a road environment, the sequence of images generated based on a vehicle traversing the road environment; a processor configured to process, in an offline simulation environment, the sequence of images with a deep reinforcement learning agent associated with a control feature of the autonomous vehicle to obtain an optimized set of control policies, and train the autonomous vehicle based on the optimized set of control polices.

In various embodiments, the processor is configured to process the sequence of images by: obtaining a first image from the sequence of images and processing the first image with the deep reinforcement learning agent to obtain an action; modifying a next image from the sequence of images based on the action; and determining the optimized set of control policies based on the modified next image.

In various embodiments, the processor is configured to determine whether the modified next image depicts an unwanted driving behavior, and when the modified next image does not depict an unwanted driving behavior, process the modified next image with the deep reinforcement learning agent to obtain a next action; when the modified next image does depict an unwanted driving behavior, process the first image with the deep learning reinforcement agent to obtain the next action.

In various embodiments, the processor is configured to compute a reward based on the modified next image, and wherein the processing the modified next image is based on the reward.

In various embodiments, the unwanted driving behavior comprises steering off the road.

In various embodiments, the unwanted driving behavior comprises steering into an object.

In various embodiments, the processor is configured to iteratively process a next image of the vision sequence with the deep reinforcement learning agent based on a computed reward associated with the next image.

In various embodiments, the control feature includes steering control of the autonomous vehicle.

In various embodiments, the action is associated with a steering angle of a steering system of the autonomous vehicle.

In another embodiment an autonomous vehicle includes: one or more sensors that sense a road environment; and a training system. The training system includes a data storage device that stores real world data including a sequence of images of the road environment, the sequence of images generated based on the autonomous vehicle traversing the road environment; and a processor configured to process offline the sequence of images with a deep reinforcement learning agent associated with a control feature of the autonomous vehicle to obtain an optimized set of control policies, and train the autonomous vehicle based on the optimized set of control polices.

In various embodiments, the processor is configured to process the sequence of images by: obtaining a first image from the sequence of images and processing the first image with the deep reinforcement learning agent to obtain an action; modifying a next image from the sequence of images based on the action; and determining the optimized set of control policies based on the modified next image.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having one or more autonomously controlled features, in accordance with various embodiments;

FIG. 2 is a training environment for training the autonomous vehicle, in accordance with various embodiments;

FIG. 3 is a dataflow diagram illustrating a training module, in accordance with various embodiments;

FIG. 4 is a flowchart illustrating a training method for training the autonomous vehicle in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, neural networks, vehicle kinematics, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

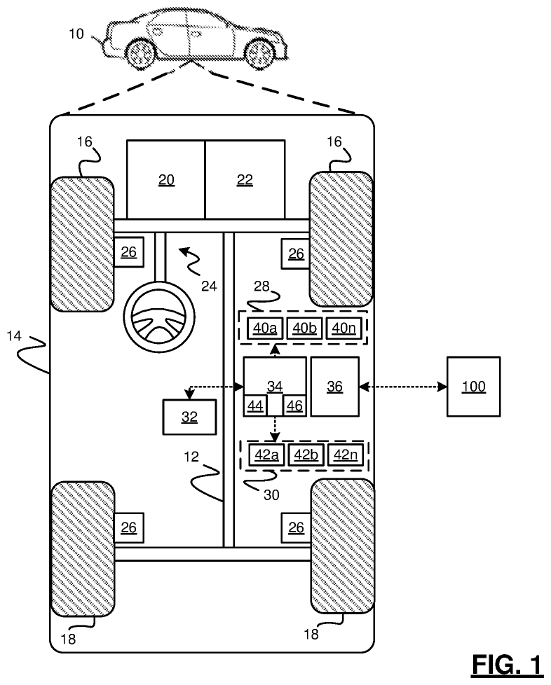

With reference to FIG. 1, a training system shown generally as 100 is associated with a vehicle 10 in accordance with various embodiments. In general, training system (or simply “system”) 100 is configured to train one or more models associated with one or more autonomous control features of the vehicle. The training system 100 trains the autonomous vehicle 10 based on real-world environment data and deep reinforcement learning methods. Thus, the training system 100 and associated methods improve the training process by no longer relying on synthesized simulation environment data.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the training system 100 is incorporated into or is communicatively coupled to the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

In an exemplary embodiment, the autonomous vehicle 10 corresponds to a level four automation system or a level two or level three automated driving assistance system (ADAS) under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level two or three ADAS takes full control of the vehicle feature however, requires some level of driver monitoring for times in which the driver will be required to take over control. It will be appreciated, however, the embodiments in accordance with the present subject matter are not limited to any particular taxonomy or rubric of automation categories.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. The braking system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n might include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the autonomous vehicle 10. In various embodiments, the data storage device 32 stores defined maps of the navigable environment. In various embodiments, the defined maps may be predefined by and obtained from a remote. For example, the defined maps may be assembled by the remote system and communicated to the autonomous vehicle 10 (wirelessly and/or in a wired manner) and stored in the data storage device 32. Route information may also be stored within data device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

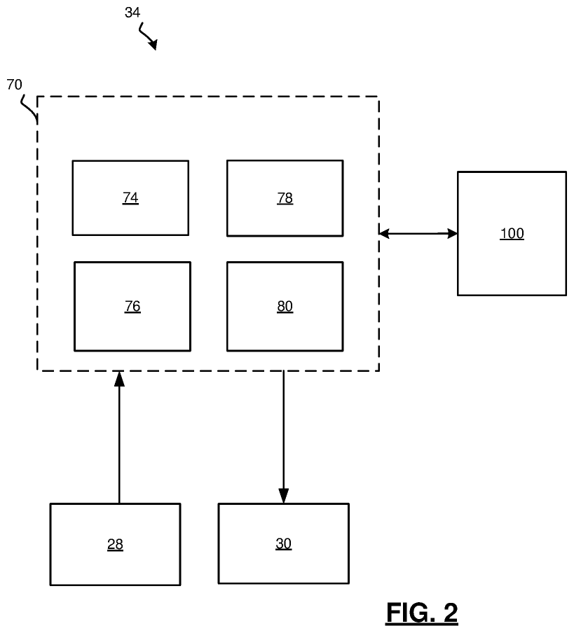

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In accordance with various embodiments, the controller 34 implements an autonomous driving system (ADS) 70 as shown in FIG. 2. That is, suitable software and/or hardware components of the controller 34 (e.g., the processor 44 and the computer-readable storage device 46) are utilized to provide an autonomous driving system 70 that is used in conjunction with the vehicle 10.

In various embodiments, the instructions of the autonomous driving system 70 may be organized by function or system. For example, as shown in FIG. 2, the autonomous driving system 70 can include a sensor fusion system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the sensor fusion system 74 synthesizes and processes sensor data and predicts the presence, location, classification, and/or path of objects and features of the environment of the vehicle 10. In various embodiments, the sensor fusion system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like. As mentioned briefly above, the training system 100 is configured to train one or models of the machine learning techniques using real-world environment data. The real-world environment data may be obtained, for example, from a vehicle similar to or the same as vehicle 10 and that has a sensor system 28 such as that of vehicle 10.

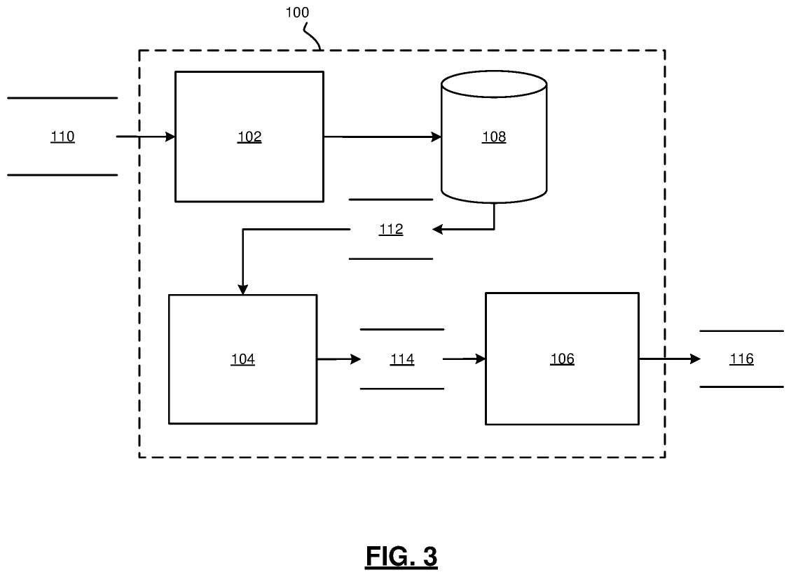

In that regard, FIG. 3 is a functional block diagram illustrating the training system 100 in accordance with various embodiments. It will be understood that the sub-modules shown in FIG. 3 can be combined and/or further partitioned to similarly perform the functions described herein. Inputs to modules may be received from a sensor system 28, received from a control module, received from a communication system 36, and/or determined/modeled by other sub-modules (not shown) within the training system 100.

In various embodiments, the training system 100 includes a vision sequence module 102, a simulation module 104, an interface module 106, and a vision sequence datastore 108. The vision sequence module 102 receives real world environment data 110 which includes image data captured of the environment by one or more sensors of the sensor system 28 (e.g., camera, lidar, etc.). The image data includes a plurality of images (or video) taken while a vehicle (does not necessarily have to be the autonomous vehicle 10) is traveling through the environment. The real world environment data 110 may further include vehicle data indicating vehicle information associated with the images. The vehicle information may include messages communicated on a bus while the images are being captured and may be associated by time with the images of the vision sequence. The vision sequence module 102 stores the real world environment data as a vision sequence 112 in the vision sequence datastore 108 for further processing.

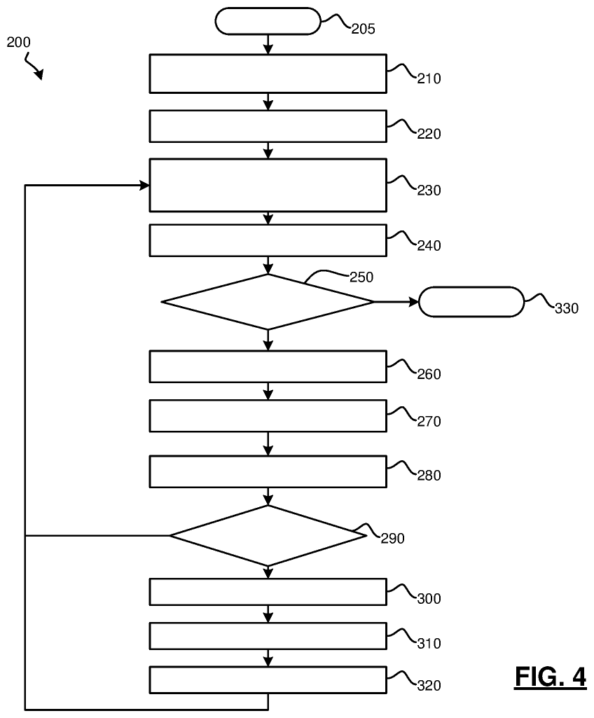

The simulation module 104 processes the vision sequence 112 in an offline simulation environment and provides simulation parameters 114. In various embodiments, the simulation module 104 processes the vision sequence 112 with deep reinforcement learning methods, for example, as will be discussed with regard to FIG. 4.

The interface module 1064 receives the simulation parameters 114 and updates a model of a control feature of the ADS 70 (FIG. 2) with the simulation parameters 114. For example, in various embodiments the control feature of the ADS 70 is associated with steering (e.g., lateral control); and the interface module 106 updates parameters of a model or models associated with steering control using the model updates 116 hat include or are based on the simulation parameters 114. For example, the parameters 114 may include a set of control policies that may be implemented in the vehicle 10 to control the steering of the autonomous vehicle 10. As can be appreciated, the training system 100 may be implemented for any number of control features in various embodiments and is not limited to the steering example.

FIG. 4 is a flowchart illustrating a method 200 of the simulation module 104 in accordance with various embodiments. As can be appreciated, the order of the steps of the method 200 may vary in various embodiments. As can further be appreciated, one or more steps of the method 200 may be added or removed without altering the spirit of the method 200 in various embodiments.

In one embodiment, the method 200 may begin at 205 The stored vision sequence 112 is processed in an offline environment using deep reinforcement learning to produce a set of policies that can be used by the control feature of the autonomous vehicle 10. For example, the simulation environment is initialized at 210 and 220. For example, an observation including a first image (and any associated vehicle data) of the vision sequence is selected at 210 and a step counter and an episode counter are set to zero at 220. Thereafter, this observation is sent to a reinforcement learning (RL) agent that evaluates the observation to determine an action at 230. In various embodiments, the reinforcement learning agent is a deep convolutional neural network that maps the observation with actions and leans policies based on associated rewards. In the example discussed above, where the control feature is associated with steering, the deep neural network includes actions implemented for a steering system, for example, the actions may include a steering angle command (e.g., twenty degrees, twenty-five degrees, etc.).

Thereafter, a next image (if another exists at 250) is obtained from the vision sequence at 240. and the step counter is incremented at 260. The action is then applied to the next image at 270. For example, when the action is a prediction of a steering angle, the next image is adjusted based on the steering angle. In other words, the center of the field of view of the sensing device is adjusted based on the angle and an adjusted image is provided.

A ground truth reward is computed based on the adjusted image at 280.

Thereafter, the adjusted image is evaluated to determine if an unwanted driving behavior occurred (e.g., steering off the road or into another object) at 290. For example, when an unwanted driving behavior occurs at 290, the observation, including the adjusted image and the ground truth reward, is sent to the RL agent for further processing at 230 to obtain a next action.

In another example, when an unwanted driving behavior does not occur at 290, the observation is reset at 300-320. For example, the first image of the vision sequence is selected at 300 and the step counter is reset to zero at 310. The episode counter is incremented at 320.

Thereafter, the method continues with processing the vision sequence with the RL agent at 230. The method continues until the entire vision sequence has been processed at 250 and a set of optimal policies has been produced. Thereafter, the method ends at 330.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of training an autonomous vehicle, comprising:
storing, in a data storage device, real world data including a sequence of images of a road environment, the sequence of images generated based on a vehicle traversing the road environment;
processing, in an offline simulation environment, the sequence of images with a deep reinforcement learning agent associated with a control feature of the autonomous vehicle to obtain an optimized set of control policies; and
training the autonomous vehicle based on the optimized set of control polices.

2. The method of claim 1, wherein the processing the sequence of images comprises:
obtaining a first image from the sequence of images and processing the first image with the deep reinforcement learning agent to obtain an action;
modifying a next image from the sequence of images based on the action; and
determining the optimized set of control policies based on the modified next image.

3. The method of claim 2, further comprising determining whether the modified next image depicts an unwanted driving behavior, and when the modified next image does not depict an unwanted driving behavior, processing the modified next image with the deep reinforcement learning agent to obtain a next action;
when the modified next image does depict an unwanted driving behavior, processing the first image with the deep learning reinforcement agent to obtain the next action.

4. The method of claim 3, further comprising computing a reward based on the modified next image, and wherein the processing the modified next image is based on the reward.

5. The method of claim 3, wherein the unwanted driving behavior comprises steering off the road.

6. The method of claim 3, wherein the unwanted driving behavior comprises steering into an object.

7. The method of claim 1, further comprising iteratively processing a next image of the vision sequence with the deep reinforcement learning agent based on a computed reward associated with the next image.

8. The method of claim 1, wherein the control feature includes steering control of the autonomous vehicle.

9. The method of claim 8, wherein the action is associated with a steering angle of a steering system of the autonomous vehicle.

10. A system for training an autonomous vehicle, comprising:
a data storage device that stores real world data including a sequence of images of a road environment, the sequence of images generated based on a vehicle traversing the road environment;
a processor configured to process, in an offline simulation environment, the sequence of images with a deep reinforcement learning agent associated with a control feature of the autonomous vehicle to obtain an optimized set of control policies, and train the autonomous vehicle based on the optimized set of control polices.

11. The system of claim 10, wherein the processor is configured to process the sequence of images by:
obtaining a first image from the sequence of images and processing the first image with the deep reinforcement learning agent to obtain an action;
modifying a next image from the sequence of images based on the action; and
determining the optimized set of control policies based on the modified next image.

12. The system of claim 11, wherein the processor is configured to determine whether the modified next image depicts an unwanted driving behavior, and when the modified next image does not depict an unwanted driving behavior, process the modified next image with the deep reinforcement learning agent to obtain a next action;
when the modified next image does depict an unwanted driving behavior, process the first image with the deep learning reinforcement agent to obtain the next action.

13. The system of claim 12, wherein the processor is configured to compute a reward based on the modified next image, and wherein the processing the modified next image is based on the reward.

14. The system of claim 12, wherein the unwanted driving behavior comprises steering off the road.

15. The system of claim 12, wherein the unwanted driving behavior comprises steering into an object.

16. The system of claim 10, wherein the processor is configured to iteratively process a next image of the vision sequence with the deep reinforcement learning agent based on a computed reward associated with the next image.

17. The system of claim 10, wherein the control feature includes steering control of the autonomous vehicle.

18. The system of claim 17, wherein the action is associated with a steering angle of a steering system of the autonomous vehicle.

19. An autonomous vehicle, comprising:
one or more sensors that sense a road environment; and
a training system comprising:
a data storage device that stores real world data including a sequence of images of the road environment, the sequence of images generated based on the autonomous vehicle traversing the road environment;
a processor configured to process offline the sequence of images with a deep reinforcement learning agent associated with a control feature of the autonomous vehicle to obtain an optimized set of control policies, and train the autonomous vehicle based on the optimized set of control polices.

20. The autonomous vehicle of claim 19, wherein the processor is configured to process the sequence of images by:
obtaining a first image from the sequence of images and processing the first image with the deep reinforcement learning agent to obtain an action;
modifying a next image from the sequence of images based on the action; and
determining the optimized set of control policies based on the modified next image.
